(19) United States
(12) Patent Application Publication
(10) Pub. No.: US 2020/0186641 A1
(43) Pub. Date: Jun. 11, 2020

(54) ELECTRONIC DEVICE AND CONTROL METHOD THEREFOR

(71) Applicant: SAMSUNG ELECTRONICS CO., LTD., Suwon-si, Gyeonggi-do (KR)

(72) Inventors: Gue-hwan MA, Seoul (KR); Hye-jin CHOI, Suwon-si, Gyeonggi-do (KR)

(21) Appl. No.: 16/638,945

(22) PCT Filed: Apr. 9, 2018
(86) PCT No.: PCT/KR2018/004148

§ 371 Date: Feb. 13, 2020

(30) Foreign Application Priority Data
Sep. 22, 2017 (KR) 10-2017-0122763

(51) Int. Cl. H04M 1/725; H04L 29/08

(52) U.S. Cl. CPC H04M 1/72583; H04L 67/306; H04M 1/72563; H04M 1/7253

(57) ABSTRACT

An electronic apparatus is provided. The electronic apparatus includes a sensor configured to sense a user manipulation, a first communicator configured to communicate with an external device through first communication method, a second communicator configured to communicate with the external device through a second communication method which is different from the first communication method, and a processor configured to, based on the user manipulation being a predetermined user gesture, control the first communicator to transmit a first signal for activating predetermined hardware configuration of the external device to the external device, and control the second communicator to transmit a second signal for performing a function corresponding to the predetermined user gesture using the configuration activated by the first signal, to the external device.

### TECHNICAL FIELD

The disclosure relates to an electronic apparatus and a controlling method thereof and more particularly, to an electronic apparatus that allows a specific function to be executed in an external device swiftly through a simple manipulation and a controlling method thereof.

### BACKGROUND ART

With the development of electronic technology, various types of electronic apparatuses have been developed and distributed. In particular, various electronic apparatuses such as TVs, mobile phones, PCs, notebook PCs, PDAs, etc. have been used.

Through electronic apparatuses, users can be provided with various services. For example, recently, TVs are not only used for watching broadcast programs but also used for various activities such as Internet searching and shopping.

AS described above, electronic apparatuses provide various functions, thereby expanding user experiences, but some cumbersome operations are required to execute each function.

Accordingly, there is a need for a new controlling method for executing the functions of electronic apparatuses more conveniently and quickly.

### DETAILED DESCRIPTION OF DISCLOSURE

### Technical Problem

The disclosure provides an electronic apparatus which allows a specific function to be executed in an external device swiftly through a simple manipulation and a controlling method thereof.

### Technical Solution

An electronic apparatus according to an embodiment may include a sensor configured to sense a user manipulation, a first communicator configured to communicate with an external device through first communication method, a second communicator configured to communicate with the external device through a second communication method which is different from the first communication method, and a processor configured to, based on the user manipulation being a predetermined user gesture, control the first communicator to transmit a first signal for activating predetermined hardware configuration of the external device to the external device, and control the second communicator to transmit a second signal for performing a function corresponding to the predetermined user gesture using the configuration activated by the first signal, to the external device.

The predetermined hardware configuration may be a communicator of the external device corresponding to the second communication method.

The first communication method may be an infrared, a Near Field Communication (NFC) or a Wireless Fidelity (WiFi) communication method, and the second communication method may be a Bluetooth, a WiFi Direct or a Wireless Display (Wi-Di) communication method.

The apparatus may further include a display configured to display an image, and the processor may be configured to, based on the user manipulation being a predetermined user gesture, control the first communicator to transmit a first signal for activating a display of the external device to the external device, and control the second communicator to transmit a second signal for displaying an image corresponding to an image displayed on the electronic apparatus, on the display of the external device, to the external device.

The processor may be configured to, based the user manipulation being a predetermined user gesture, control the first communicator to transmit a signal for activating a display of the external device to the external device, and control the second communicator to transmit a signal for displaying an image of a predetermined channel on the display of the external device, to the external device.

The processor may be configured to, based on the user manipulation being a predetermined user gesture, control the first communicator to transmit a signal for activating a display of the external device to the external device, and control the second communicator to transmit a signal for displaying a specific image in a predetermined image quality on the display of the external device, to the external device.

The processor may be configured to, based on the user manipulation being a predetermined user gesture, control the first communicator to transmit a signal for activating a speaker of the external device to the external device, and control the second communicator to transmit a signal for outputting a specific sound at a predetermined sound level through the speaker of the external device, to the external device.

The processor may be configured to, based on the user manipulation being a predetermined user gesture, control the first communicator to transmit a signal for inactivating a display of the external device and activating a speaker of the external device to the external device, and control the second communicator to transmit a signal for outputting a specific sound through the speaker of the external device, to the external device.

The apparatus may further include a memory configured to store gesture information regarding each of a plurality of users, and the processor may be configured to, based on user recognition information being input and a user manipulation being sensed through the sensor, identify whether the sensed user manipulation is a predetermined user gesture based on gesture information of a user corresponding to the user recognition information from among the plurality of users.

The sensor may include at least one of a sensor for sensing a movement of the electronic apparatus, a sensor for sensing a touch regarding the electronic apparatus, or a sensor for sensing a pressure regarding the electronic apparatus.

The external device may be configured to include a transceiver capable of communicating with the electronic apparatus through the first communication method and the second communication method, and the processor may be configured to, based on the user manipulation being a predetermined user gesture, control the first communicator to transmit a first signal for performing a function of the second communication method to the transceiver of the external device.

A controlling method of an electronic apparatus according to an embodiment includes sensing a user manipulation through a sensor of the electronic apparatus, based on the user manipulation being a predetermined user gesture, transmitting a first signal for activating predetermined hardware configuration of the external device to the external device through a first communication method, and transmitting a second signal for performing a function corresponding to the predetermined user gesture using the configuration activated by the first signal, to the external device through a second communication method which is different from the first communication method.

The predetermined hardware configuration may be a communicator of the external device corresponding to the second communication method.

The first communication method may be an infrared, a Near Field Communication (NFC) or a Wireless Fidelity (WiFi) communication method, and the second communication method may be a Bluetooth, a WiFi Direct or a Wireless Display (Wi-Di) communication method.

The method may further include displaying an image through a display of the electronic apparatus, the predetermined hardware configuration may be a display of the external device, and the transmitting a signal to the external device through the second communication method may include transmitting a signal for displaying an image corresponding to an image displayed on a display of the electronic apparatus, on a display of the external device, to the external device through the second communication method.

Meanwhile, the predetermined hardware configuration may be a display of the external device, and the transmitting a signal to the external device through the second communication method may include transmitting a signal for displaying an image of a predetermined channel on the display of the external device, to the external device through the second communication method.

Meanwhile, the predetermined hardware configuration may be a display of the external device, and the transmitting a signal to the external device through the second communication method may include transmitting a signal may include transmitting a signal for displaying a specific image in a predetermined image quality on the display of the external device, to the external device through the second communication method.

Meanwhile, the predetermined hardware configuration may be a speaker of the external device, and the transmitting a signal to the external device through the second communication method may include transmitting a signal for outputting a specific sound at a predetermined sound level through the speaker of the external device, to the external device through the second communication method.

Meanwhile, the transmitting a signal to the external device through the first communication method includes, based on the user manipulation being a predetermined gesture, transmitting a signal for inactivating a display of the external device and activating a speaker of the external device, to the external device through the first communication method, and transmitting a signal to the external device through the second communication method includes transmitting a signal for outputting a specific sound through the speaker of the external device, to the external device through the second communication method.

The controlling method of an electronic apparatus according to an embodiment may further include storing gesture information for each of a plurality of users, and based on user recognition information being input and a user manipulation being sensed through the sensor, identifying whether the sensed user manipulation is a predetermined user gesture based on gesture information of a user corresponding to the user recognition information from among the plurality of users.

Meanwhile, in a recording medium including a program for executing a controlling method of an electronic apparatus according to an embodiment, the controlling method includes based on a user manipulation sensed through a sensor being a predetermined user gesture, controlling the electronic apparatus to transmit a first signal for activating predetermined hardware configuration of an external device, to the external device through first communication method and controlling the electronic apparatus to transmit a second signal for performing a function corresponding to the predetermined user gesture using the configuration activated by the first signal, to the external device through second communication method which is different from the first communication method.

### BRIEF DESCRIPTION OF THE DRAWINGS

FIG. 1 is a block diagram provided to explain configuration of an electronic apparatus according to an embodiment;

FIG. 2 is a view provided to explain various embodiments in which an electronic apparatus controls an external device;

FIG. 3 is a view provided to explain various embodiments in which an electronic apparatus controls an external device;

FIG. 4 is a view provided to explain various embodiments in which an electronic apparatus controls an external device;

FIG. 5 is a view provided to explain a UI provided by an electronic apparatus according to an embodiment;

FIG. 6 is a flowchart provided to explain a method in which an electronic apparatus controls an external device according to an embodiment;

FIG. 7 is a block diagram provided to explain configuration of an electronic apparatus according to another embodiment;

FIG. 8 is a block diagram provided to explain an external device controlled by an electronic apparatus according to an embodiment; and

FIG. 9 is a flowchart provided to explain a controlling method of an electronic apparatus according to an embodiment.

### BEST MODE

Before specifically describing the present disclosure, a method for drafting the present specification and drawings will be described.

Terms used in the present disclosure are selected as general terminologies currently widely used in consideration of the configuration and functions of the present disclosure, but can be different depending on intention of those skilled in the art, a precedent, appearance of new technologies, and the like. Further, in specific cases, terms may be arbitrarily selected. Such terms may be construed according to meanings defined in the present specification, and may also be construed based on general contents of the present specification and a typical technical concept in the art unless the terms are not specifically defined.

Also, the same reference numerals or symbols described in the attached drawings denote parts or elements that actually perform the same functions. For convenience of descriptions and understanding, the same reference numerals or symbols are used and described in different exemplary embodiments. In other words, although elements having the same reference numerals are all illustrated in a plurality of drawings, the plurality of drawings do not mean one exemplary embodiment.

In addition, in order to distinguish between the components, terms including an ordinal number such as “first”, “second”, etc. may be used in the present specification and claims. The ordinal numbers are used in order to distinguish the same or similar elements from one another, and the use of the ordinal number should not be understood as limiting the meaning of the terms. For example, used orders, arrangement orders, or the like of elements that are combined with these ordinal numbers may not be limited by the numbers. The respective ordinal numbers are interchangeably used, if necessary.

The singular expression also includes the plural meaning as long as it does not differently mean in the context. The terms “include”, “comprise”, “is configured to,” etc., of the description are used to indicate that there are features, numbers, steps, operations, elements, parts or combination thereof, and they should not exclude the possibilities of combination or addition of one or more features, numbers, steps, operations, elements, parts or a combination thereof.

In the exemplary embodiment of the present disclosure, the term “module,” “unit,” or “part” is referred to as an element that performs at least one function or operation, and may be implemented with hardware, software, or a combination of hardware and software. In addition, a plurality of “modules,” a plurality of “units,” a plurality of “parts” may be integrated and implemented with at least one processor, except when a “module,” a “unit,” or a “part” has to be implemented with specific hardware.

Also, when any part is connected to another part, this includes a direct connection and an indirect connection through another medium. Further, when a certain portion includes a certain element, unless specified to the contrary, this means that another element may be additionally included, rather than precluding another element.

Hereinafter, the present disclosure will be described in detail with reference to the attached drawings.

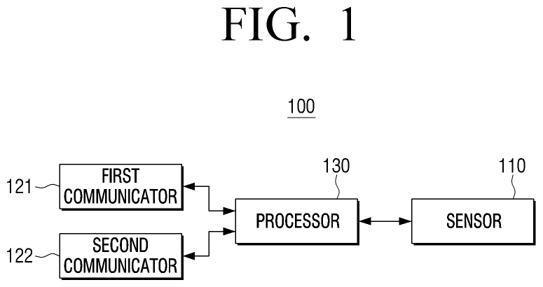

FIG. 1 is a block diagram provided to explain configuration of an electronic apparatus 100 according to an embodiment.

Referring to FIG. 1, the electronic apparatus 100 includes a sensor 110, a first communicator 121, a second communicator 122, and a processor 130.

The electronic apparatus 100 may be implemented in various types of devices such as a remote controller, a mobile phone, a smartphone, a tablet PC, a smart watch, a smart band, a PDA, and the like.

The sensor 110 is configured to sense a user manipulation. Here, the user manipulation may be any manipulation that a user may apply to the electronic apparatus 100. For example, the user manipulation may be at least one of a manipulation in which a user moves the electronic apparatus 100, a manipulation in which a user touches the electronic apparatus 100, a manipulation in which a user makes a specific gesture at a certain distance from the electronic apparatus, a manipulation in which a user applies pressure to the electronic apparatus 100, or a manipulation in which the electronic apparatus folds the electronic apparatus 100 when the electronic apparatus is a flexible device (an electronic apparatus that can be curved, bent, folded, or rolled like a paper).

For example, the sensor 110 may be a sensor that can sense a movement of the electronic apparatus 100. In this case, the sensor 110 may include at least one of, for example, a geomagnetic sensor, an acceleration sensor, or a gyro sensor. The acceleration sensor outputs a sensing value corresponding to the gravitational acceleration that changes according to the inclination of the device to which the sensor is attached. The gyro sensor is a sensor that detects an angular velocity by measuring the force of the Coriolis being applied in the velocity direction when a rotational movement occurs. The geomagnetic sensor is a sensor for detecting azimuth.

As another example, the sensor 110 may be a sensor that can sense a touch manipulation. In this case, the sensor 110 may, for example, include at least one of a capacitance-type touch sensor or a resistive-type touch sensor. The capacitive-type touch sensor calculates a touch coordinates by sensing micro-electricity excited by a user body when part of the user body touches the surface of the electronic apparatus 100 using a dielectric coated on the surface of the electronic apparatus 100. The resistive-type touch sensor comprises two electrode plates, and calculates a touch coordinates as the upper and lower plates of the touched point contact with each other to sense flowing electric current when a user touches a screen.

As another example, the sensor 110 may be a sensor that can sense an object which is spaced apart by a predetermined distance without contacting the electronic apparatus 100. In this case, the sensor 110 may be, for example, a proximity sensor.

As another example, if the electronic apparatus 100 is flexible, the sensor 110 may be a bend sensor. The bend sensor is a sensor that can be bent by itself and has a characteristic that a resistance value varies according to the degree of bending. The bend sensor may be implemented as a strain gauge. The strain gauge detects the deformation of the surface of the object according to a change of the resistance by using metals or semiconductors whose resistance varies greatly with the magnitude of the force applied. In general, a material such as a metal has a property that the resistance increases as the length increases with the force from the outside, and the resistance decreases when the length decrease. Accordingly, the resistance value of the bend sensor may be detected using the magnitude of the voltage applied to the bend sensor or the magnitude of the current flowing through the bend sensor, and the bending state of the corresponding bending sensor may be detected according to the magnitude of the resistance value.

As another example, the sensor 110 may be a pressure sensor that can sense a pressure applied to the electronic apparatus 100. As another example, the sensor 110 may be an image sensor (e.g., a camera module) capable of capturing a subject.

The sensor 110 may be one of the above-described various types of sensors, or may include two or more types of sensors.

The first communicator 121 is configured to perform communication with an external device through the first communication method, and the second communicator 110 is configured to perform communication with an external device through a communication method that is different from the first communication method.

For example, the first communication method may be a communication method with less power consumption than the second communication method. Alternatively, the second communication method may be a communication method suitable for communication over a longer distance than the first communication method. The second communication method may be more suitable for transmitting a larger amount of data than the first communication method.

The first communication method used by the first communicator 121 and the second communication method used by the second communicator 122 may, for example, be one of Infrared Data Association (IrDA), Radio Frequency Identification (RFID), Near Field Communication (NFC), Wireless Fidelity (WiFi), ultra wideband (UWB), WirelessDisplay (WiDi), WirelessHD (WiHD), Wireless Home Digital Interface (WHDI), Miracast, Wireless Gigabit Alliance (Wigig), WiFi Direct, Bluetooth (e.g., Bluetooth Classic), Bluetooth Low Energy, AirPlay, Z-wave, 4LoWPAN, LTE D2D, GPRS, Weightless, Edge Zigbee, Digital Living Network Alliance (DLNA), ANT+, Digital Enhanced Cordless Telecommunications (DECT), wireless local area network (WLAN), Global System for Mobile (GSM) communications, Universal Mobile Telecommunication System (UMTS), Long-Term Evolution (LTE), Wireless Broadband (WiBRO), etc.

The first communicator 121 and the second communicator 122 may be implemented in a separate hardware configuration. Alternatively, the first communicator 121 and the second communicator 122 may be implemented in one hardware configuration. For example, if the first communication method used by the first communicator 121 is a WiFi communication method, and the second communication method used by the second communicator 122 is a WiFi Direct communication method which is different from the WiFi communication method, the first communicator 121 and the second communicator 122 may be implemented in one transceiver (e.g., a WiFi module). As another example, if the first communication method used by the first communicator 121 is a WiFi communication method, and the second communication method used by the second communicator 122 is a Bluetooth communication method, the first communicator 121 and the second communicator 122 may be implemented as one transceiver (e.g., a combo module of Bluetooth and WiFi). Other than the above combination, there may be various kinds of combinations.

According to an embodiment, the first communication method used by the first communicator 121 may be an infrared communication method, and the second communication method used by the second communicator 122 may be a Bluetooth communication method.

The processor 130 is configured to control the overall operations of the electronic apparatus 100. The processor 130 may be implemented as CPU, ASIC, SoC, MICOM, etc.

The processor 130 may identify whether a user manipulation sensed by the sensor 110 is a predetermined user gesture and perform an operation corresponding to the predetermined gesture. For example, if the user manipulation sensed by the sensor 110 is a predetermined user gesture, the processor 130 may control the first communicator 121 to transmit the first signal for activating predetermined hardware configuration of an external device to the external device and control the second communicator 122 to transmit the second signal for performing a function corresponding to the predetermined user gesture using the configuration activated by the transmitted first signal to the external device.

Here, the external device may be any device with a communication function. For example, the external device may be a computer, a TV, a set-top box, an air conditioner, a printer, washing machine, a refrigerator, a cleaner, an air purifier, etc.

Activating the hardware configuration of an external device means that the corresponding hardware configuration can function normally, and activation may also be referred to as wake-up. For example, if power is not supplied to the hardware function, activating the corresponding hardware configuration may include the process supplying power so that the hardware configuration can function normally. As another example, when power is supplied to the hardware function, but there is a limitation in performing a function, activating the corresponding hardware configuration includes the process of allowing the hardware configuration to fully perform a function, which may include the process of supplying power to other hardware configurations related to the corresponding hardware configuration. For example, when a TV is turned off (connected to a power outlet) and the power-on-button is pressed with a remote controller, a screen is displayed on the display of the TV. This process can be viewed as activating the display of the TV.

The first signal for activating predetermined hardware configuration of an external device refers to a signal for activating the hardware configuration of the external device that requires activation to execute a function corresponding to a predetermined user gesture. For example, the first signal may be a signal for activating a communicator required to receive the second signal from the external device, that is, for activating the communicator of the external device corresponding to the second communication method. The first signal may be a signal for activating only the hardware function of the external device which required activation to execute a function corresponding to the predetermined user gesture, or may be a signal for also activating other hardware configurations including the above hardware configuration.

Meanwhile, if the external device includes one transceiver capable of communicating with the electronic apparatus in the first communication method and the second communication method, when a user manipulation is a predetermined user gesture, the processor 130 may control the first communicator 121 to transmit a signal for performing a communication function of the second communication method to the transceiver of the external device. For example, when the first communication method is a WiFi communication method, and the second communication method is a WiFi Direct communication method, the external may perform not only the WiFi communication method but also the WiFi Direct communication method through one transceiver, for example, a WiFi module. In this case, if the sensed user manipulation is a predetermined user gesture, the processor 130 may transmit a signal for the WiFi module of the external device to perform the WiFi Direct communication function to the WiFi module of the external device through the WiFi communication method and subsequently, may transmit the second signal for performing a function corresponding to the predetermined user gesture to the WiFi module of the external device through the WiFi Direct communication method. In this embodiment, the external device does not receive the second signal through the hardware configuration activated by the received signal through the first communication method, but receive the second signal through the WiFi module which is already activated.

The second signal for executing a function corresponding to the predetermined user gesture may include a control command for executing the corresponding function. For example, if the function corresponding to the predetermined user gesture is an audio streaming function through a Bluetooth from the electronic apparatus 100 to the external device, when the user manipulation sensed through the sensor 110 corresponds to the predetermined user gesture, the processor 130 may control the first communicator 210 to transmit the first signal for activating the communicator corresponding to the Bluetooth communication method in the external device, and control the second communicator having a Bluetooth communication function to transmit the second signal including audio streaming data through the Bluetooth communication method.

The reason behind using the first communication method and the second communication method which is different from the first communication method is to reduce power consumption even if both the first communication method and the second communication method are supported in the external device. In a turn-off state, only a communicator corresponding to the first communication method suitable for relatively less power consumption and simple data transmission may be activated and used. Therefore, the first communication method is used to activate a communicator corresponding to the second communication method so that the second communication method is used.

According to the embodiment described above, there is an advantage that activating the hardware configuration of the external device 200 and executing a desired function may be performed at once through a simple user manipulation.

According to an embodiment, a screen mirroring function in which the screen is shared between the electronic apparatus 100 and the external device may be performed through a simple manipulation. Specifically, the electronic apparatus 100 includes a display for displaying an image, and if a user manipulation sensed by the sensor 110 is a predetermined user gesture regarding a mirroring function, the processor 130 may control the first communicator 121 to transmit a signal for activating the display of the external device to the external device, and control the second communicator 122 to transmit a signal for displaying an image corresponding to the image displayed on the display of the electronic apparatus, on the display of the external device, to the external device.

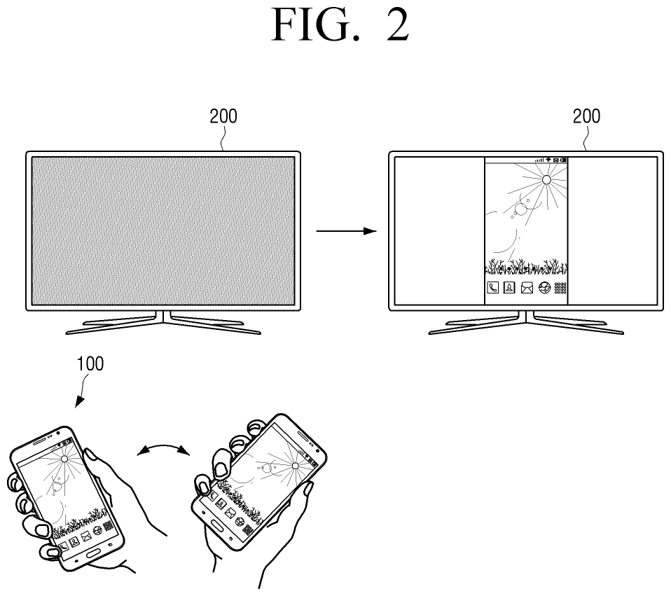

FIG. 2 is a view provided to explain an embodiment related to execution of a mirroring function.

Referring to FIG. 2, if it is preset that the user manipulation of waving the electronic apparatus 100 left and right is a user gesture corresponding to a screen mirroring function for sharing a screen between the electronic apparatus 100 and the external device 200, when the user waves the electronic apparatus 100 left and right, the sensor 110 senses the manipulation and the processor 130 identifies whether the sensed manipulation corresponds to a predetermined user gesture for the mirroring function.

If it is identified that the manipulation sensed by the sensor 110 corresponds to the predetermined user gesture for the screen mirroring function, the processor 130 may control the first communicator 121 to transmit a signal for activating the hardware configuration of the external device required for performing the screen mirroring function through the first communication method. As illustrated in FIG. 2, if the external device is a TV and the TV is turned off, since a TV may generally receive an infrared signal even in a turn-off state, the first communication method may be an infrared communication method. Alternatively, if the external device 200 is connected to a wireless access point and WiFi communication is possible, the first communication method may be a WiFi communication method.

The hardware configurations of the external device 200 required to perform the mirroring function may include, for example, a communicator for receiving information regarding an image displayed on the electronic apparatus 100 and a display for displaying an image based on the received information.

Therefore, the signal that is transmitted by the electronic apparatus 100 through the first communication method may be a signal for activating at least one of the communicator and the display of the external device 200. The communicator of the external device 200 activated by the transmitted signal through the first communication method may correspond to the second communication method which is different from the first communication method. For example, the second communication method may be WiFi Direct, Bluetooth, Miracast, WiDi, etc.

In addition, the electronic apparatus 100 may exchange various connection information with the external device 200 in order for a communication connection (e.g., pairing) between the electronic apparatus 100 and the external device 200 through the second communication method. If there is a connection history between the external device 200 and the electronic apparatus 100, the external device 200 and the electronic apparatus 100 may be communicatively connected automatically based on the connection history.

When the communication connection of the second communication method is established between the electronic apparatus 100 and the external device 200, the processor 130 may control the second communicator 122 to transmit a signal for displaying an image corresponding to the image displayed on the electronic apparatus 100, on the external device 200, to the external device 200 through the second communication method. For example, the image displayed on the electronic apparatus 100 may be packet-converted through a codec and converted to a MPEG transport stream (TS) signal, and the converted signal may be transmitted to the external device 200 through the second communication method. The external device 200 may restore the received data to the original data through a decoder and output the data on the display.

Accordingly, as illustrated in FIG. 2, the same image as the image displayed on the electronic apparatus 100 may be displayed on the external device 200.

According to an embodiment which is described with reference to FIG. 2, even though a user does not perform various manipulations such as turning on the external device 200, setting a communication connection between the external device 200 and the electronic apparatus 100, etc., it is possible to perform a screen mirroring function through a simple manipulation to the electronic apparatus 100. Thus, user convenience can be improved.

Meanwhile, in the above description, only the screen mirroring is explained, but a sound may be mirrored in the similar manner.

According to another embodiment, it is possible to watch a desired channel in a TV which is an external device through a simple manipulation. Specifically, if the user manipulation sensed by the sensor 110 is a predetermined user gesture regarding the function of displaying a predetermined channel by the external device, the processor 130 may control the first communicator 121 to transmit a signal for activating the display of the external device to the external device, and control the second communicator 122 to transmit a signal for displaying an image of the predetermined channel on the display of the external display to the external display.

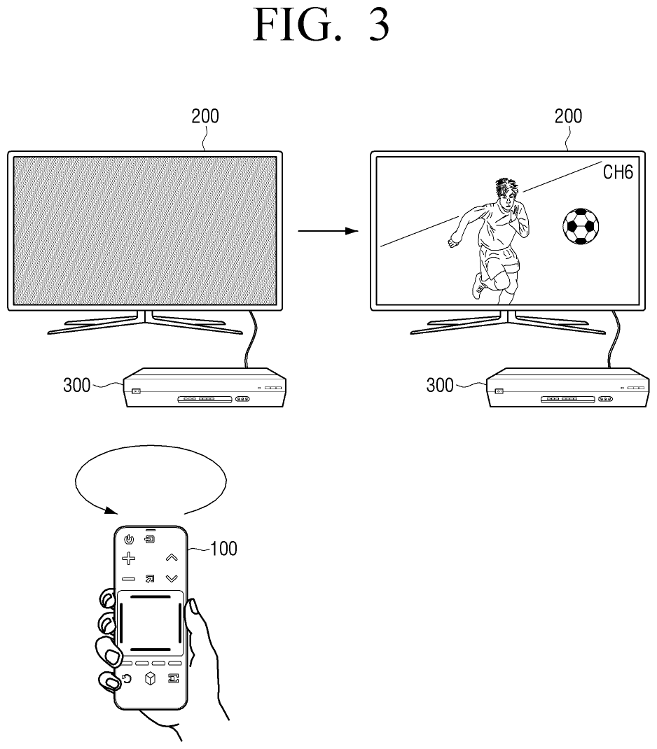

FIG. 3 is a view provided to explain an embodiment related to execution of a function of displaying an image of a predetermined channel.

Referring to FIG. 3, if it is preset that the user manipulation of whirling the electronic apparatus 100 is a user gesture corresponding to the function of displaying an image of channel 6 on a TV which is the external device 200, when the user grips and whirls the electronic apparatus 100, the sensor 110 senses this manipulation and the processor 130 identifies whether the sensed manipulation corresponds to the predetermined user gesture regarding the function of displaying an image of channel 6 on the external device 200.

If it is identified that the manipulation sensed by the sensor 110 corresponds to the predetermined user gesture regarding the function of displaying an image of channel 6 on the external device 200, the processor 130 may control the first communicator 121 to transmit a signal for activating the hardware configuration of the external device 200 required to perform the function of displaying an image of channel 6 through the first communication method. As illustrated in FIG. 3, if the external device is a TV and the TV is turned off, since a TV may generally receive an infrared signal even in a turn-off state, the first communication method may be an infrared communication method. Alternatively, if the external device 200 is connected to a wireless access point and WiFi communication is possible, the first communication method may be a WiFi communication method.

The hardware configurations of the external device 200 required to perform the function of displaying an image of a predetermined channel may include a communicator for receiving a control signal to change channels and a display for displaying an image.

Accordingly, the signal transmitted by the electronic apparatus 100 through the first communication method may be a signal for activating at least one of the communicator or the display of the external device 200. Such a signal may be a signal for turning on the external device 200. The communication of the external device 200 which is activated by the signal transmitted through the first communication method may correspond to the second communication method which is different from the first communication method. For example, the second communication method may be WiFi, Bluetooth, etc.

In addition, the electronic apparatus 100 may exchange various connection information with the external device 200 for a communication connection (e.g., pairing) between the electronic apparatus 100 and the external device 200 through the second communication method. If the second communication method is WiFi or Bluetooth, the electronic apparatus 100 and the external device 200 may be communicatively connected by transmitting/receiving various connection information such as SSID, a session key, etc.

Once the communication connection of the second communication method is established between the electronic apparatus 100 and the external device 200, the processor 130 may control the second communicator 122 to transmit a control signal corresponding to channel 6 to the external device 200 through the second communication method. The external device 200 which receives the control signal from the electronic apparatus through the second communication method may transmit a control signal for switching to channel 6 to the set-top box 300. The external device 200 may transmit the control signal for switching to channel 6 to the set-top box 300 through, for example, a wired communication method such as HDMI, etc. or a wireless communication method such as infrared, Bluetooth, WiFi, etc. The set-top box 300 may receive the control signal from the external device 200, and provide an image of channel 6 to the external device 200. Accordingly, the image of channel 6 may be displayed on the external device 200 as illustrated in FIG. 3.

According to an embodiment described with reference to FIG. 3, even if a user does not perform various manipulations such as turning on the external device 200, selecting a channel, etc., the user may watch a desired channel through a simple manipulation to the electronic apparatus 100. Thus, user convenience can be improved.

According to another embodiment of the present disclosure, a user may watch an image in a desired image quality in an external device through a simple manipulation. Specifically, if the user manipulation sensed by the sensor 110 is a predetermined user gesture regarding a function of displaying an image in a predetermined image quality by the external device, the processor 130 may control the first communicator 121 to transmit a signal for activating the display of the external device to the external device, and control the second communicator 122 to transmit a signal for displaying a specific image at the predetermined image quality on the display of the external display to the external device.

According to an embodiment, even if a user does not perform various manipulations such as activating the display of the external device 200, setting the image quality, etc., the user may watch the specific image in a desired image quality through a simple manipulation to the electronic apparatus 100. Thus, user convenience can be improved.

In the similar manner to the above method, a specific sound can be output in a desired sound mode in an external device. Specifically, if the user manipulation sensed by the sensor 110 is a predetermined user gesture regarding the function of outputting a specific sound in a predetermined sound mode (e.g., a mode in which a sound is output at a specific sound level, a 5.1 channel mode, a high sound quality mode, etc.) by the external device, the processor 130 may control the first communicator 121 to transmit a signal for activating the speaker of the external device to the external device, and control the second communicator 122 to transmit a signal for outputting a specific sound in the predetermined sound mode through the speaker of the external device to the external device.

According to an embodiment, even if a user does not perform various manipulations such as activating the speaker of the external device 200, setting a sound mode, etc., the user may listen to a specific sound in a desired sound mode through a simple manipulation to the electronic apparatus 100. Thus, user convenience can be improved.

Meanwhile, in the above-described embodiments, an image quality and a sound mode are set by an individual user manipulation, respectively, but a specific image quality and a specific sound mode may be mapped to one user manipulation simultaneously. In this case, only one user manipulation may display an image in a specific image quality and output a sound in a specific sound mode. For example, if a user manipulation of touching a specific portion of the electronic apparatus 100 for a predetermined time is sensed by the sensor 110, the processor 130 may transmit a signal for activating the display and the speaker of the external device to the external device through the first communicator 121, and transmit a signal for outputting an image quality corresponding to a movie mode and a specific content in a high sound quality mode to the external device through the second communicator 122.

According to another embodiment, a simple manipulation may execute the function of using an external device including a display, for example, a TV, only as a speaker.

Specifically, if the user manipulation sensed by the sensor 110 is a predetermined user gesture regarding the function of using an external device including a display only as a speaker, the processor 130 may control the first communicator 121 to transmit a signal for inactivating the display of the external device and activating the speaker of the external device to the external device, and control the second controller 122 to transmit a signal for outputting a specific sound through the speaker of the external device to the external device.

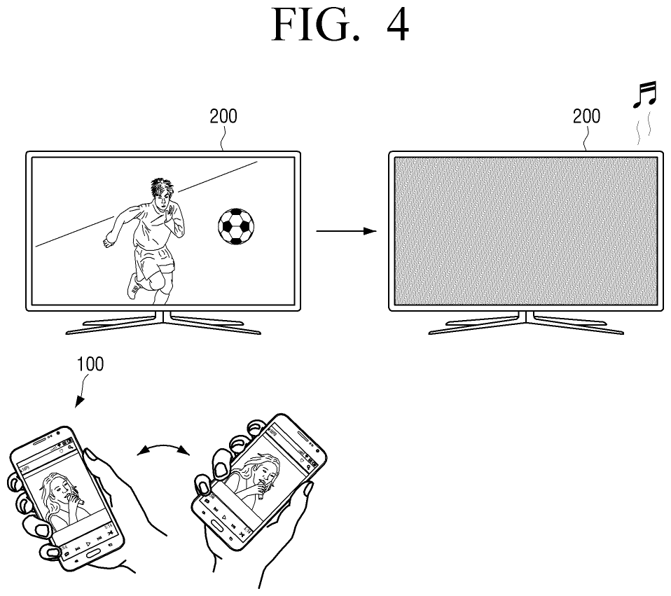

FIG. 4 is a view provided to explain an embodiment related to execution of a function of using an external device including a display as a speaker.

Referring to FIG. 4, if the user manipulation of shaking the electronic apparatus 100 left and right is preset as a user gesture corresponding to the function of using the external device 200 as a speaker, when the user moves the electronic apparatus 100 left and right, the sensor 110 senses the movement, and the processor 130 identifies whether the sensed manipulation corresponds to the predetermined user gesture regarding the function of using the external device 200 as a speaker.

If it is identified that the manipulation sensed by the sensor 110 corresponds to the predetermined user gesture regarding the function of using the external device 200 as a speaker, the processor 130 may control the first communicator 121 to transmit a signal for activating the hardware configuration of the external device 200 required to perform the corresponding function through the first communication method.

The hardware configurations of the external device 200 required to perform the function of using the external device 200 as a speaker may include the communicator and the speaker for receiving sound data from the electronic apparatus 100. Meanwhile the signal transmitted through the first communication method may be a signal for activating the speaker of the external device 200 and inactivating the display. Accordingly, the display of the external device 200 may be turned off.

The communicator of the external device 200 which is activated by the signal transmitted through the first communication method may correspond to the second communication method that is different from the first communication method. For example, the second communication method may be WiFi Direct, Bluetooth, etc.

In addition, the electronic apparatus 100 may exchange various connection information with the external device for a communication connection (e.g., pairing) between the electronic apparatus 100 and the external device 200 through the second communication method. If there is a connection history between the external device 200 and the electronic apparatus 100, the external device 200 and the electronic apparatus 100 may be communicatively connected automatically based on the connection history.

When the communication connection of the second communication method is established between the electronic apparatus 100 and the external device 200, the processor 130 may control the second communicator 122 to transmit a signal for outputting a specific sound of the electronic apparatus 100 from the external device 200, to the external device 200 through the second communication method. For example, the electronic apparatus 100 may convert an audio content into a MPEG transport stream (TS) signal through a codec, transmit the converted signal to the external device 200 through the second communication method, and the external device 200 may restore the received signal to the original data through an audio recorder and output the same through the speaker.

Accordingly, as illustrated in FIG. 4, the display of the external device 200 is inactivated, and the sound provided from the electronic apparatus 100 may be output. Such a state in which the display is inactivated and the speaker is activated may be referred to as a power saving state. The external device 200 may operate in the power saving state, and by outputting only the sound and inactivating the display, power consumption can be reduced.

According to an embodiment described with reference to FIG. 4, even if a user does not perform various manipulations, the external device 200 including a display may be used as, for example, a Bluetooth speaker through a simple manipulation to the electronic apparatus 100.

The electronic apparatus 100 may be provided with contents through various communication interface ports, for example, if the electronic apparatus 100 is a TV, contents may be provided through an antenna input port, a High-Definition Multimedia Interface (HDMI) input port, a USB port, a component input jack, etc. The external device may be provided with contents from various other external devices through the above ports. According to an embodiment, with only a simple manipulation to the electronic apparatus 100, it is possible to select through which port the external device to receive contents.

Specifically, when the external device is turned off, a user may turn on the external device, receive contents through a specific communication port of the external device and output the corresponding contents immediately only by making a specific gesture on the electronic apparatus 100. For example, if the user manipulation sensed by the sensor 110 is a predetermined user gesture regarding the function of receiving contents from a USB port of the external device, the processor 130 may control the first communicator 121 to transmit a signal for activating the hardware configuration (e.g., the USB port of the external device, the display, the communicator corresponding to the second communication method, etc.) of the external device required to perform the function to the external device through the first communication method. In addition, the processor 130 may control the second communicator 122 to transmit a signal for receiving contents from the USB connected to the external device and output the contents to the external device through the second communication method.

According to an embodiment, a user may make a simple gesture without go through various manipulation such as turning on the external device, selecting a content source, etc. to output a content provided from a specific content source through the external device.

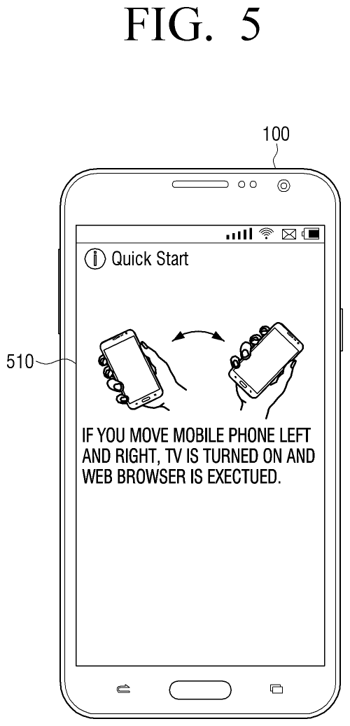

According to another embodiment of the present disclosure, information regarding a user gesture for executing a function of an external device may be provided to the user. For example, a guide UI 510 informing the user of what gesture should be performed in the electronic apparatus 100 to perform a specific function may be output, of which embodiment will be described with reference to FIG. 5.

FIG. 5 is a view provided to explain a UI provided by the electronic apparatus 100 according to an embodiment.

Referring to FIG. 5, if a specific user manipulation is input in the electronic apparatus 100, the external device is turned on and a guide UI indicating that a specific application is executed may be provided in the electronic apparatus 100. The external device may store various applications (e.g., a mail application, a game application, a web browser application, a streaming content providing application, VOD content providing application, etc.), and with a simple user manipulation on the electronic apparatus 100, the external device may be turned on and at the same time, a specific application may be executed.

If it is sensed through the sensor 110 that a user moves the electronic apparatus 100 left and right based on the guide UI 510, the processor 130 turns on the TV which is the external device and identifies whether the manipulation corresponds to a predetermined user gesture regarding the function of executing a web browser application. If it is identified that it is the predetermined user gesture regarding the corresponding function, the processor 130 may control the first communicator 121 to transmit a signal for activating the hardware configuration of the external device which is required to perform the corresponding function through the first communication method. The signal transmitted through the first communication method may be a signal for turning on the TV. In general, a TV may receive an infrared signal even in a turn-off state and thus, the first communication method may be an infrared communication method. Alternatively, if the TV is connected to a wireless access point and WiFi communication is possible, the first communication method may be a WiFi communication method.

In addition, the electronic apparatus 100 may transmit a signal for executing a web browsing application to the TV through the second communication method. In this case, the second communication method may be WiFi, Bluetooth, etc. Accordingly, the web browsing application may be executed in the TV.

According to the above embodiment, even though a user does not perform various manipulations such as turning on the TV, selecting an application to be executed, etc., a desired application can be executed quickly through a simple manipulation to the electronic apparatus 100. Thus, user convenience can be improved.

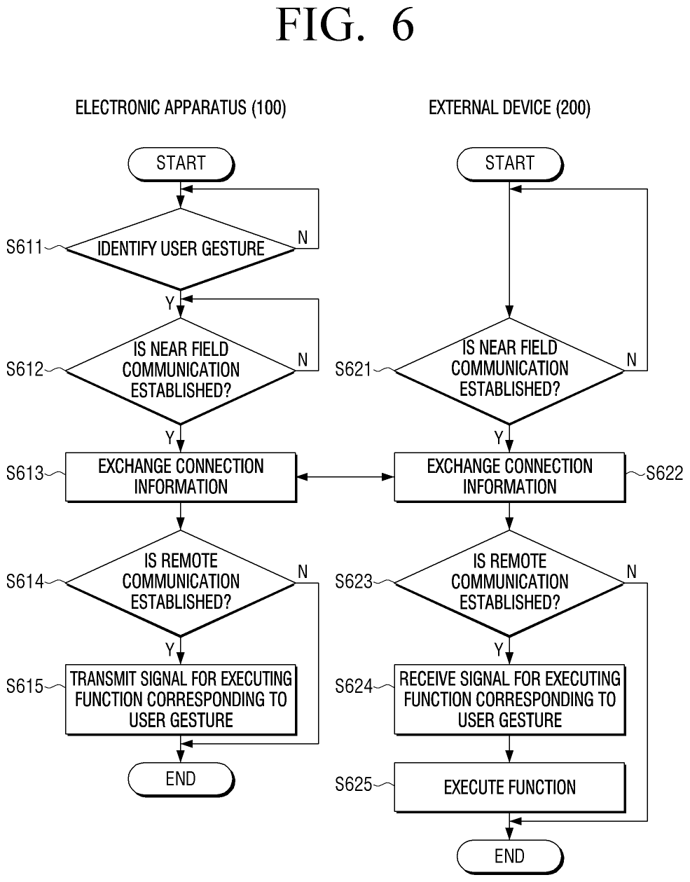

FIG. 6 is a flowchart provided to explain an embodiment regarding establishment of wireless communication between the electronic apparatus 100 and the external device 200.

Referring to FIG. 6, first of all, if a user manipulation is sensed by the sensor 110 of the electronic apparatus 100, it is identified whether the sensed user manipulation is a predetermined user manipulation corresponding to execution of a specific function of the external device 200 (S611). If it is not identified, wait for a user manipulation again and repeat the step of S611.

If it is identified that the sensed user manipulation corresponds to a predetermined user manipulation regarding execution of a specific function of the external device 200, it is identified whether a near field communication connection is established between the electronic apparatus 100 and the external device 200 (S612, S621). Here, the near field communication connection is established through the first communicator 121 using the first communication method. The first communicator 121, for example, may perform communication in a Near Field Communication (NFC) method. In this case, the first communicator 121 has a function of a reader or a tag that reads information from the NFC communicator of the external device 200 in a non-contact manner. The first communicator 121 that performs communication in the NFC communication method establishes a communication connection with the NFC communicator of the external device 200 when it is present within a communication range of the NFC communicator of the external device 200. Meanwhile, the communication method of the first communicator 121 may be other communication methods such as Infrared Data Association (IrDA), etc.

Once a near field communication connection is established, the electronic apparatus 100 exchanges connection information with the external device 200 through the first communicator 121 (S613, S622). Here, the connection information is initial setting information required for remote communication with the external device 200 through the second communicator 122. The second communicator 122 may perform communication through the second communication method such as a Bluetooth communication method, etc. capable of performing communication more remotely than the first communication method. Meanwhile, in addition to exchange of connection information, the electronic apparatus 100 may transmit a signal for activating the hardware configuration of the external device 200 required to perform a function corresponding to a user gesture to the external device 200 through the first communication method. This signal may include a signal for activating the communicator of the external device 200 corresponding to the second communication method.

If a remote communication connection according to the second communication method is established between the electronic apparatus 100 and the external device 200 based on connection information exchanged through the first communication method (S614, S623), a signal for executing a function corresponding to an identified user gesture in the external device 200 is transmitted to the external device 200 through the second communication method (S615), and the external device 200 receives the signal (S624). The external device 200 executes the corresponding function based on the received signal (S625).

As such, the electronic apparatus 100 receives connection information for a remote communication connection from the external device 200 through a near field communication method such as NFC which facilitates the transmission and reception of data and thus, a user may specify the external device 200 which is a communication counterpart only by causing the electronic apparatus 100 to near the external device 200 without any special manipulation and remote communication is possible. Thus, user convenience can be improved. In addition, by simply brining the electronic apparatus 100 to the external device 200 after performing a specific gesture such as holding and shaking the electronic apparatus 100, a function of the external device 200 corresponding to the above gesture may be performed automatically. Thus, there is the advantage that the function can be executed quickly.

Meanwhile, in the above description, an embodiment in which remote communication is established between the electronic apparatus 100 and the external device 200 is explained, but according to another embodiment, the external device 200 may provide connection information of another external device to the electronic apparatus 100 in the step of exchanging connection information (S613, S622), and a remote communication connection may be established between the electronic apparatus 100 and another external device based on this. For example, if the external device 200 is a remote controller and another external device is a TV, a user may communicatively connect the external apparatus 100 to the TV simply by bringing the electronic apparatus 100 to the remote controller and accordingly, a function corresponding to a user gesture may be executed on the TV.

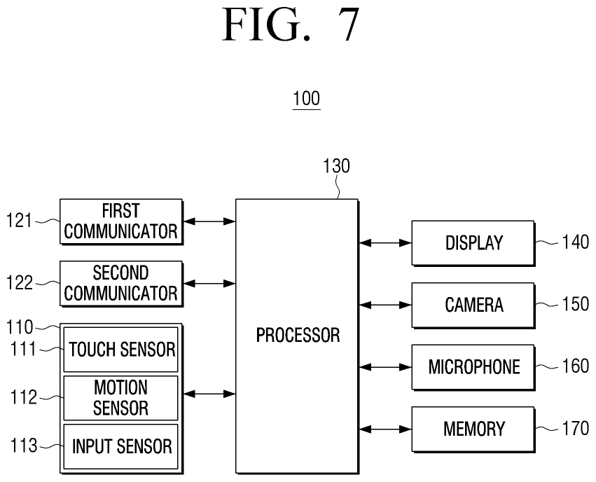

FIG. 7 is a block diagram provided to explain configuration that may be added to the electronic apparatus 100 described with reference to FIGS. 1 to 6. For the overlapping configurations, the above descriptions thereof may be cited.

Referring to FIG. 7, the electronic apparatus 100 may include all or at least some of the sensor 110, the first communicator 121, the second communicator 122, the processor 130, a display 140, a camera 150, a microphone 160, or a memory 170.

The sensor 110 may include a touch sensor 111, a motion sensor 112 (e.g., a gyro sensor, an acceleration sensor, a gravity sensor, etc.), a pressure sensor 113, etc.

The first communicator 121 and the second communicator 122 perform communication in different communication methods, and for example, the first communicator 121 may perform communication in infrared, NFC or WiFi communication method, and the second communicator 122 may perform communication in Bluetooth, WiFi Direct or WiDi communication method.

The memory 170 stores various data and programs necessary for driving the electronic apparatus 100. The memory 170 may be implemented as a non-volatile memory, a volatile memory, a flash memory, a hard disk drive (HDD), or a solid state drive (SSD). The memory 170 may be implemented not only as a storage medium in the electronic apparatus 100 but also as an external storage medium, for example, a micro SD card, a USB memory, or a web server through a network.

The memory 170 may store an application program for executing a controlling method of the electronic apparatus 100 according to an embodiment. Such an application program may be always running in the background of the electronic apparatus 100 and thus, a user may execute a corresponding function simply by inputting a gesture without a particular manipulation of executing an application. For example, if the electronic apparatus 100 is a smartphone, the application may operate even if the display of the smartphone is turned off. Alternatively, the application may be set not to be executed in the background. This is to prevent an operation according to a gesture from being executed when the user does not intend it and in this case, the user may execute the application and take the gesture only when he or she wishes to use the application.

The memory 170 may store gesture information. The gesture information may include information regarding which external device is controlled by a specific user manipulation, and which function of the external device is to be executed. For example, the memory 170 may store gesture information including information indicating that the external device mapped to the user manipulation of shaking the electronic apparatus 100 left and right is a TV and that the screen mirroring function is executed on the TV. Such gesture information may be generated by the user taking a specific manipulation with the electronic apparatus 100 and selecting an external device and a function of the external device to be mapped with the manipulation.

Meanwhile, if the electronic apparatus 100 is shared by a plurality of users, for example, if the electronic apparatus which is a remote controller is shared by a plurality of users in a home, the memory 170 may store gesture information regarding each of the plurality of users. If a user inputs user identification information such as an iris or a fingerprint, or a pin number or a pattern and then, manipulates the electronic apparatus 100, the processor 130 may identify whether the user manipulation is a predetermined user gesture based on the user gesture information corresponding to the input user recognition information from among a plurality of pieces of user gesture information stored in the memory 170.

According to an embodiment, there is the advantage that with only one electronic apparatus 100, a plurality of users may control the external device according to a gesture set by the users individually.

The processor 130 controls the overall operations of the electronic apparatus 100 and a signal flow between internal components of the electronic apparatus 100, and perform a function of processing data. The processor 130 accesses the memory 170 and performs booting using an operating system stored in the memory 170. In addition, the processor 130 may perform various operations using various programs, contents, data, etc. stored in the memory 170.

When various types of user manipulations are detected through the sensor 110, the camera 150, the microphone 160, etc., the processor 130 identifies whether an event matching event information stored in the memory 170 occurs using the detection result. IN addition, the processor 130 may identify whether an event occurs using a result of detection by a timer or other configurations. As described above, the event may be set in various ways. For example, there may be an event in which a user touches or selects a button, an event in which a motion gesture, a voice commend, etc. is input, an event in which an application execution command is input, an event in which a content playback command is input, an event in which a predetermined time or period arrives, an event in which a system notification message is generated, an event in which communication with an external source is established, etc.

The display 140 is configured to display various screens. The display 140, for example, may be implemented as Liquid Crystal Display (LCD), and depending on circumstances, may be implemented as a cathode-ray tube (CRT), a plasma display panel (PDP), an organic light emitting diodes (OLED), a transparent OLED (TOLED), etc. In addition, the display 140 may be implemented in the form of a touch screen which is combined with the touch sensor 111 to sense a user's touch manipulation.

The display 140 may display a setting UI for setting a gesture. The setting UI may induce a user to input a gesture and select an external device and a function of the external device to be mapped with the gesture. In addition, the display 140 may display a guide UI for guiding the stored gesture, and the user may take a gesture as informed by the guide UI.

The camera 150 is configured to capture a still image or a moving image under the control of a user. The camera 150 may be implemented in plurality, such as a front camera and a real camera. The microphone is configured to receive a user voice or other sounds and convert the same into audio data. In the above embodiments, gestures such as a motion gesture, a touch gesture, etc. is used, but the embodiment of the present disclosure may be implemented with a voice command through the microphone 160. For example, when a voice command “send a screen to a TV” is input through the microphone 160, as described above with reference to FIG. 2, a screen mirroring function between the electronic apparatus 100 and the external device 200 may be executed. In addition, embodiments of the present disclosure may be implemented with a motion captured through the camera 150.

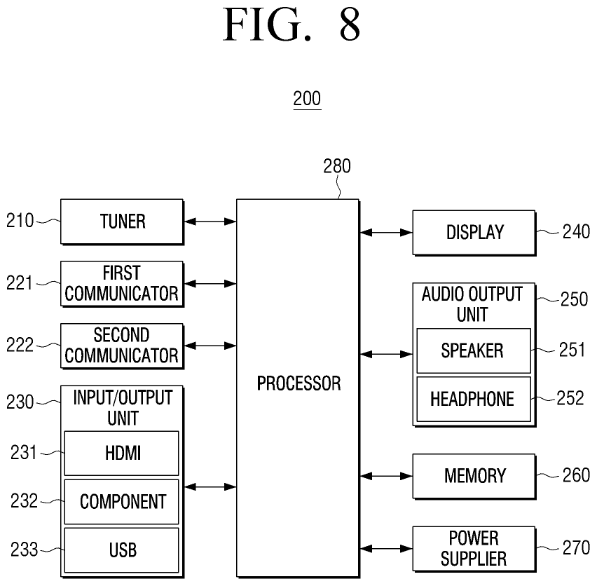

FIG. 8 is a block diagram provided to explain an example of an external device controlled by the electronic apparatus 100 according to an embodiment.

The external device 200 may be implemented, for example, as an analog TV, a digital TV, a 3D-TV, a smart TV, an LED TV, an OLED TV, a plasma TV, a monitor, a curved TV having a fixed curvature screen, a flexible TV having a fixed curvature screen, a bended TV having a fixed curvature screen, and/or a variable curvature TV that can change the curvature of the current screen by a received user input, but is not limited thereto.

The external device 200 may include a tuner 210, a first communicator 221, a second communicator 222, an input/output unit 230, a display 240, an audio output unit 250, a memory 260, and a power supplier 270.

The tuner 210 may tune and select only the frequency of a channel to be received from the external device 200 from among a number of radio wave components through amplification, mixing, resonance, etc. of the broadcast signal received by wire or wirelessly. The broadcast signal may include video, audio and additional data (e.g., Electronic Program Guide (EPG)).

The tuner 210 may receive broadcast signals from various sources such as terrestrial broadcast, cable broadcast, or satellite broadcast.

The tuner 210 may be implemented as an all-in-one with the external device 200, or as a separate device (e.g., a set-top box, a tuner connected to the input/output unit 230) having a tuner unit that is electrically connected to the external device 200.

The first communicator 221 is configured to perform communication with another device in the first communication method, and the second communicator 210 is configured to perform communication with another device in another communication method which is different from the first communication method. The first communication method of the first communicator 221 may correspond to the first communication method of the first communicator 121 of the electronic apparatus 100, and the second communication method of the second communicator 222 may correspond to the second communication method of the second communicator 122 of the electronic apparatus 100.

The first communication method used by the first communicator 221 or the second communication method used by the second communicator 222 may be one of, for example, infrared Data Association (IrDA), Radio Frequency Identification (RFID), Near Field Communication (NFC), Wireless Fidelity (WiFi), ultra wideband (UWB), WirelessDisplay (WiDi), WirelessHD (WiHD), Wireless Home Digital Interface (WHDI), Miracast, Wireless Gigabit Alliance (Wigig), WiFi Direct, Bluetooth (e.g., Bluetooth Classic, Bluetooth Low Energy), AirPlay, Z-wave, 4LoWPAN, LTE D2D, GPRS, Weightless, Edge Zigbee, Digital Living Network Alliance (DLNA), ANT+, Digital Enhanced Cordless Telecommunications (DECT), wireless local area network (WLAN), Global System for Mobile communications (GSM), Universal Mobile Telecommunication System (UMTS), Long-Term Evolution (LTE), Wireless Broadband (WiBRO), etc.

The first communicator 221 and the second communicator 222 may be implemented as separate hardware. Alternatively, the first communicator 221 and the second communicator 222 may be implemented as one hardware. For example, if the first communication used by the first communicator 221 is a WiFi communication method, and the second communication method used by the second communicator 222 is a WiFi Direct which is different from WiFi, the first communicator 221 and the second communicator 222 may be implemented as one transceiver (e.g., a WiFi module). As another example, if the first communication method used by the first communicator 221 is a WiFi communication method, and the second communication method used by the second communicator 222 is a Bluetooth communication method, the first communicator 221 and the second communicator 222 may be implemented as one transceiver (e.g., a Bluetooth+WiFi combo module). In addition to the above combination, there may be various types of combination.

According to an embodiment, the first communication method used by the first communicator 221 may be an infrared communication method, and the second communication method used by the second communicator 222 may be a Bluetooth communication method.

The input/output unit 230 is configured to be connected to another device. The input/output unit 230 may include at least one of a High-Definition Multimedia Interface port 231, a component input jack 232, and a USB port 233. The input/output port 230 may further include at least one of RGB, DVI, HDMI, DP, Thunder Bolt, etc.

The display 240 is configured to display an image and for example, may be implemented as Liquid Crystal Display (LCD), and depending on circumstances, may be implemented as a cathode-ray tube (CRT), a plasma display panel (PDP), an organic light emitting diodes (OLED), a transparent OLED (TOLED), etc. In addition, the display 240 may be implemented in the form of a touch screen capable of sensing a user's touch manipulation.

The audio output unit 250 is configured to output audio and for example, may output audio included in a broadcast signal received through the tuner 210, audio input through the first communicator 211, the second communicator 212, the input/output unit 230, etc., or audio included in an audio file stored in the memory 260. The audio output unit 250 may include a speaker 251 and a headphone output terminal 252.

The memory 260 may store various data, programs or applications required to drive and control the external device 200 under the control of a processor 280. The memory 260 may be implemented as a non-volatile memory, a volatile memory, a flash memory, a hard disk drive (HDD), or a solid state drive (SSD). The memory 260 may be implemented not only as a storage medium in the electronic apparatus 200 but also as, for example, a micro SD card, a USB memory, or a web server through a network.

The power supplier 270 may supply power input from an external power source to components in the external device 200 under the control of the processor 280.

The processor 280 controls the overall operations of the electronic apparatus 200 and a signal flow between internal components of the electronic apparatus 200, and perform a function of processing data. The processor 280 may be implemented as, for example, CPU, ASIC, SoC, MICOM, etc.

The processor 280 may control the power supplied to the internal components from the power supplier 270. The processor 280 accesses the memory 260 and performs booting using the operating system stored in the memory 260. In addition, the processor 280 may perform various operations using various programs, contents, data, etc. stored in the memory 260.

The external device 200 may be operated in a turn-off state or in a turn-on state. The turn-off state refers to a state in which the external device 200 is connected to the power outlet, but power is turned off, and the turn-on state refers to a state in which an image is displayed through the display 240.

The processor 280 may include a main processor which operates in a turn-on state and does not operate in a turn-off state and a sub processor which operates in a turn-off state. In the turn-off state, the first communicator 221 is activated, and if a control signal for turning on is received through the first communicator 221, the sub processor may wake up the main processor.

Meanwhile, the external device 200 may operate in a power saving state, and in the power saving state, the main processor may operate, the display 240 may be inactivated, and the speaker 251 may be activated.

In the turn-off state, the sub processor may control the power supplier 270 to supply power to the first communicator 221. According to a signal received from the electronic apparatus 100 through the first communicator 221, the sub processor may wake up the main processor, and the main processor may activate the second communicator 222 and other hardware configurations according to the received signal.

According to an embodiment, it is possible for a user to designate a communication method to be performed in the turn-off state. For example, if the external device 200 is implemented as a TV, a function of turning on the TV using WiFi through a setting menu provided by the external device 200. The setting menu may be provided as a UI screen displayed through the display 240. If the function of turning on the TV using WiFi is set, the sub processor may supply power to the first communicator 221 that supports the WiFi communication method, and when a TV power-on signal is received from the electronic apparatus 100 through the WiFi communication method, the sub processor may wake up the main processor. According to an embodiment, for example, a device such as a smartphone can be used to turn on a TV while the TV is turned off.

When a signal for executing a specific function is received from the electronic apparatus 100 through the second communicator 122 in the second communication method, the processor 280 may perform the corresponding function. Meanwhile, according to an embodiment, the signal transmitted by the electronic apparatus 100 in the second communication method simply includes information indicating which user gesture is detected, and the external apparatus 200 may identify a function corresponding to the user gesture and perform the identified function. IN this case, the memory 260 may store various gesture information. According to another embodiment, when the signal transmitted by the electronic apparatus 100 in the second communication method may include information informing a function corresponding to the user gesture, and the external device 200 may perform the corresponding function accordingly. In other words, the operation of identify which function the user gesture corresponds to may be performed in the electronic apparatus 100 or in the external device 200.

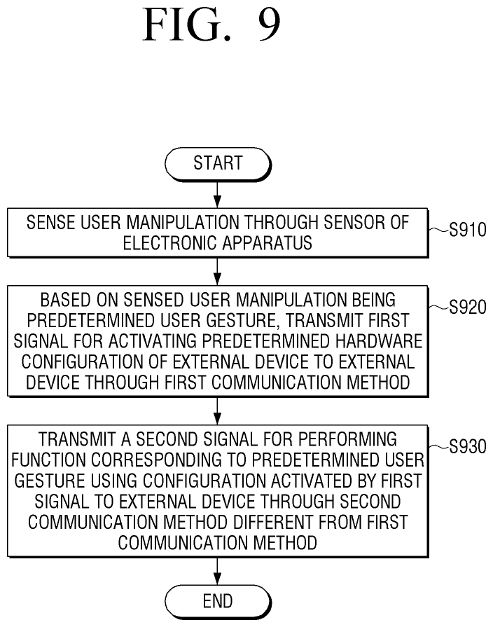

FIG. 9 is a flowchart provided to explain a controlling method of the electronic apparatus 100 according to an embodiment. The flowchart illustrated in FIG. 9 may consist of operations processed by the electronic apparatus 100 described in the present specification. Accordingly, even if omitted below, the description related to the electronic apparatus 100 may be applied to the flowchart of FIG. 9.

Referring to FIG. 9, first of all, a user manipulation is sensed through a sensor of an electronic apparatus (S910). In this case, various types of user manipulations may be sensed through various sensors such as a touch sensor, a motion sensor, an image sensor (a camera module), etc.

If the sensed user manipulation is a predetermined user gesture, the first signal for activating predetermined hardware configuration of an external device is transmitted to the external device through the first communication method (S920).

In this case, if the predetermined hardware configuration is already activated in the external device, the external device may disregard the first signal. Meanwhile, if the predetermined hardware configuration is plural and some of the plurality of hardware configurations are inactivated and the others are activated in the external device, the external device may receive the first signal to activate the inactivated hardware configurations and maintain the activated configurations.

Meanwhile, according to another embodiment, the electronic apparatus 100 may request status information from an external device to identify whether it is necessary to transmit the first signal. For example, based on the status information received from the external device, the external device is already turned on and thus, it is not necessary to transmit the first signal for turning on the external device, the electronic apparatus 100 may directly transmit the second signal without transmitting the first signal. For example, when the electronic apparatus 100 and the external device are connected to the same AP and WiFi communication is possible, the status information of the external device may be transmitted from the external device to the electronic apparatus 100 in the WiFi communication method.

The electronic apparatus 100 transmits the second signal for performing a function corresponding to the predetermined user gesture using the configuration activated by the first signal to the external device through the second communication method which is different from the first communication method (S930). Accordingly, the function corresponding to the user gesture may be executed immediately in the external device which receives the second signal.

Meanwhile, in the above-described embodiments, a signal for activating the hardware configuration of an external device and a signal for executing a specific function using the activated hardware configuration are transmitted through different communication methods, but in some cases, they may be transmitted in the same communication method. For example, the electronic apparatus 100 may turn on the external device in the WiFi communication method and transmit information regarding a screen to be mirrored to the external device in the WiFi communication method.

According to the above-described embodiments, even if cumbersome operation is not performed, only a simple manipulation to the electronic apparatus 100 may achieve the effect of executing a desired function quickly. In particular, there is an advantaged that a desired function can be executed quickly while the external device is turned off.

Meanwhile, the various embodiments described above may be implemented in a computer or a computer readable recording medium using software, hardware, or a combination of software and hardware. According to a hardware implementation, the embodiments described in the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. According to software implementation, the embodiments such as procedures and functions described in the disclosure may be implemented as separate software modules. Each of the software modules described above may perform one or more functions and operations described in the disclosure

Meanwhile, computer instructions for performing processing operations of the electronic apparatus 100 according to the diverse embodiments of the disclosure described above may be stored in a non-transitory computer readable medium. The computer instructions stored in the non-transitory computer readable medium allow a specific device to perform the processing operations of the electronic apparatus 100 according to the diverse embodiments described above when being executed by a processor of the specific device

The non-transitory computer readable medium is not a medium that stores data for a short time such as a register, a cache, a memory, or the like, but means a machine readable medium that semi-permanently stores data. Specifically, various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like,

Although the embodiments of the disclosure are illustrated and described hereinabove, the disclosure is not limited to the abovementioned specific embodiments, but may be variously modified by those skilled in the art to which the disclosure pertains without departing from the scope and spirit of the disclosure claimed in the claims. These modifications should also be understood to fall within the scope of the disclosure.

What is claimed is:

1. An electronic apparatus comprising:
a sensor configured to sense a user manipulation;
a first communicator configured to communicate with an external device through a first communication method;
a second communicator configured to communicate with the external device through a second communication method which is different from the first communication method; and
a processor configured to, based on the user manipulation being a predetermined user gesture, control the first communicator to transmit a first signal for activating predetermined hardware configuration of the external device to the external device, and control the second communicator to transmit a second signal for performing a function corresponding to the predetermined user gesture using the configuration activated by the first signal, to the external device.

2. The apparatus as claimed in claim 1, wherein the predetermined hardware configuration is a communicator of the external device corresponding to the second communication method.

3. The apparatus as claimed in claim 1, wherein the first communication method is an infrared, a Near Field Communication (NFC) or a Wireless Fidelity (WiFi) communication method, and
wherein the second communication method is a Bluetooth, a WiFi Direct or a Wireless Display (Wi-Di) communication method.

4. The apparatus as claimed in claim 1, further comprising;
a display configured to display an image,
wherein the processor is configured to, based on the user manipulation being a predetermined user gesture, control the first communicator to transmit a first signal for activating a display of the external device to the external device, and control the second communicator to transmit a second signal for displaying an image corresponding to an image displayed on the electronic apparatus, on the display of the external device, to the external device.

5. The apparatus as claimed in claim 1, wherein the processor is configured to, based the user manipulation being a predetermined user gesture, control the first communicator to transmit a signal for activating a display of the external device to the external device, and control the second communicator to transmit a signal for displaying an image of a predetermined channel on the display of the external device, to the external device.

6. The apparatus as claimed in claim 1, wherein the processor is configured to, based on the user manipulation being a predetermined user gesture, control the first communicator to transmit a signal for activating a display of the external device to the external device, and control the second communicator to transmit a signal for displaying a specific image in a predetermined image quality on the display of the external device, to the external device.

7. The apparatus as claimed in claim 1, wherein the processor is configured to, based on the user manipulation being a predetermined user gesture, control the first communicator to transmit a signal for activating a speaker of the external device to the external device, and control the second communicator to transmit a signal for outputting a specific sound at a predetermined sound level through the speaker of the external device, to the external device.

8. The apparatus as claimed in claim 1, wherein the processor is configured to, based on the user manipulation being a predetermined user gesture, control the first communicator to transmit a signal for inactivating a display of the external device and activating a speaker of the external device to the external device, and control the second communicator to transmit a signal for outputting a specific sound through the speaker of the external device, to the external device.

9. The apparatus as claimed in claim 1, further comprising:
a memory configured to store gesture information regarding each of a plurality of users,
wherein the processor is configured to, based on user recognition information being input and a user manipulation being sensed through the sensor, identify whether the sensed user manipulation is a predetermined user gesture based on gesture information of a user corresponding to the user recognition information from among the plurality of users.

10. The apparatus as claimed in claim 1, wherein the sensor includes at least one of a sensor for sensing a movement of the electronic apparatus, a sensor for sensing a touch regarding the electronic apparatus, or a sensor for sensing a pressure regarding the electronic apparatus.

11. The apparatus as claimed in claim 1, wherein the external device is configured to include a transceiver capable of communicating with the electronic apparatus through the first communication method and the second communication method, and
wherein the processor is configured to, based on the user manipulation being a predetermined user gesture, control the first communicator to transmit a first signal for performing a function of the second communication method to the transceiver of the external device.

12. A controlling method of an electronic apparatus comprising:
sensing a user manipulation through a sensor of the electronic apparatus;
based on the user manipulation being a predetermined user gesture, transmitting a first signal for activating predetermined hardware configuration of the external device to the external device through a first communication method; and
transmitting a second signal for performing a function corresponding to the predetermined user gesture using the configuration activated by the first signal, to the external device through a second communication method which is different from the first communication method.

13. The method as claimed in claim 12, wherein the predetermined hardware configuration is a communicator of the external device corresponding to the second communication method.

14. The method as claimed in claim 12, wherein the first communication method is an infrared, a Near Field Communication (NFC) or a Wireless Fidelity (WiFi) communication method, and
wherein the second communication method is a Bluetooth, a WiFi Direct or a Wireless Display (Wi-Di) communication method.

15. The method as claimed in claim 12, further comprising:
displaying an image through a display of the electronic apparatus,
wherein the predetermined hardware configuration is a display of the external device, and
wherein the transmitting a signal to the external device through the second communication method comprises transmitting a signal for displaying an image corresponding to an image displayed on a display of the electronic apparatus, on a display of the external device, to the external device through the second communication method.
